(19) United States
(12) Patent Application Publication
(10) Pub. No.: US 2026/0023314 A1
(43) Pub. Date: Jan. 22, 2026

(54) LIGHT SOURCE AND PROJECTOR

(71) Applicant: SEIKO EPSON CORPORATION, Tokyo (JP)

(72) Inventor: Hiroaki MIYA, MATSUMOTO-SHI (JP)

(21) Appl. No.: 19/272,024

(22) Filed: Jul. 17, 2025

(30) Foreign Application Priority Data
Jul. 18, 2024 (JP) 2024-115042

(51) Int. Cl. G03B 21/20

(52) U.S. Cl. CPC G03B 21/208

(57) ABSTRACT

A light source according to the present disclosure includes a light source section that emits a light including a first beam and a second beam arranged in a direction along a first axis, in a direction intersecting the first axis, a light enlargement system that generates an enlarged light by enlarging the light in a direction along a second axis orthogonal to the first axis, a superimposing optical system that superimposes the enlarged light emitted from the light enlargement system on an illuminated region, and a light scanning section that scans with a light incident from the superimposing optical system in the direction along the first axis on the illuminated region.

The present application is based on, and claims priority from JP Application Serial Number 2024-115042, filed Jul. 18, 2024, the disclosure of which is hereby incorporated by reference herein in its entirety.

### BACKGROUND

### 1. Technical Field

The present disclosure relates to a light source and a projector.

### 2. Related Art

As a light source used for a projector, a light source that illuminates a light modulation device such as a liquid crystal panel by temporally scanning the light modulation device with a light emitted from an optical element is proposed. JP-A-2007-225956 discloses a projector including a light source including a light source lamp, a liquid crystal light valve, a polygonal mirror disposed between the light source and the liquid crystal light valve, and a projection lens.

JP-A-2007-225956 is an example of the related art.

In the projector of JP-A-2007-225956, since the polygon mirror condenses the light emitted from the light source on the liquid crystal light valve while reflecting the light, there is a problem that it is difficult to effectively generate the rectangular illumination light extending in the direction orthogonal to the scanning direction with respect to the liquid crystal light valve.

### SUMMARY

According to a first aspect of the present disclosure, there is provided a light source including a light source section that emits a light including a first beam and a second beam arranged in a direction along a first axis, in a direction intersecting the first axis, a light enlargement system that generates an enlarged light by enlarging the light in a direction along a second axis orthogonal to the first axis, a superimposing optical system that superimposes the enlarged light emitted from the light enlargement system on an illuminated region, and a light scanning section that scans with a light incident from the superimposing optical system in the direction along the first axis on the illuminated region.

According to a second aspect of the present disclosure, there is provided a light source including a light source section that emits a light including a plurality of beams emitted from light emitting points on the same plane, a first lenticular lens and a second lenticular lens that generate an enlarged light by enlarging the light in a direction along a third axis, a superimposing optical system that superimposes the enlarged light on an illuminated region, and a light scanning section that scans with the enlarged light emitted from the superimposing optical system in a direction along a fourth axis orthogonal to the third axis.

According to a third aspect of the present disclosure, there is provided a projector including the light source according to the first aspect or the second aspect, a light modulation device that modulates a light incident from light the source according to image information, and a projection optical device that projects the light modulated by the light modulation device.

### BRIEF DESCRIPTION OF THE DRAWINGS

FIG. 1 is a plan view showing a schematic configuration of a projector as seen from a +Y side.

FIG. 2 is a plan view showing a schematic configuration of the projector as seen from a +Z side.

FIG. 3 shows a relationship established between respective optical members in a plan view in a Y-axis direction.

FIG. 4A shows a behavior of a blue beam when a transmissive optical element rotates.

FIG. 4B shows a behavior of the blue beam when the transmissive optical element rotates.

FIG. 4C shows a behavior of the blue beam when the transmissive optical element rotates.

FIG. 4D shows a behavior of the blue beam when the transmissive optical element rotates.

FIG. 4E shows a behavior of the blue beam when the transmissive optical element rotates.

FIG. 5 shows a behavior of a light transmitted through the transmissive optical element at color switching.

FIG. 6 shows a relationship established between the respective optical members in a plan view in a Z-axis direction.

FIG. 7 is a plan view showing a schematic configuration of a light enlargement system of a first modification example as seen from the +Y side.

FIG. 8 is a perspective view showing a main part of a light source section of a second modification example.

### DESCRIPTION OF EMBODIMENTS

An embodiment of the present disclosure will be described below with reference to the drawings.

A projector of the embodiment is an example of a liquid crystal projector using a liquid crystal panel as a light modulation device.

In the following drawings, some component elements may be shown at different dimensional scales for clarity of the respective component elements. The following description with reference to the drawings will be made by using an XYZ orthogonal coordinate system as necessary. An X axis is an axis parallel to an illumination optical axis of a light source. The illumination optical axis is defined as an axis along a principal ray of an illumination light emitted from the light source. A Z axis is an axis orthogonal to the X axis and extends along a rotation axis O of a transmissive optical element 41. A Y axis is an axis orthogonal to the X axis and the Z axis. The Y axis of the embodiment corresponds to an example of “first axis” of the present disclosure, and the Z axis of the embodiment corresponds to an example of “second axis” of the present disclosure.

Hereinafter, for description of the configurations and arrangements of the respective members, one side (+X side) and the other side (−X side) in the direction along the X axis may be collectively referred to as “X-axis direction”, one side (+Y side) and the other side (−Y side) in the direction along the Y axis may be collectively referred to as “Y-axis direction”, and one side (+Z side) and the other side (−Z side) in the direction along the Z axis may be collectively referred to as “Z-axis direction”.

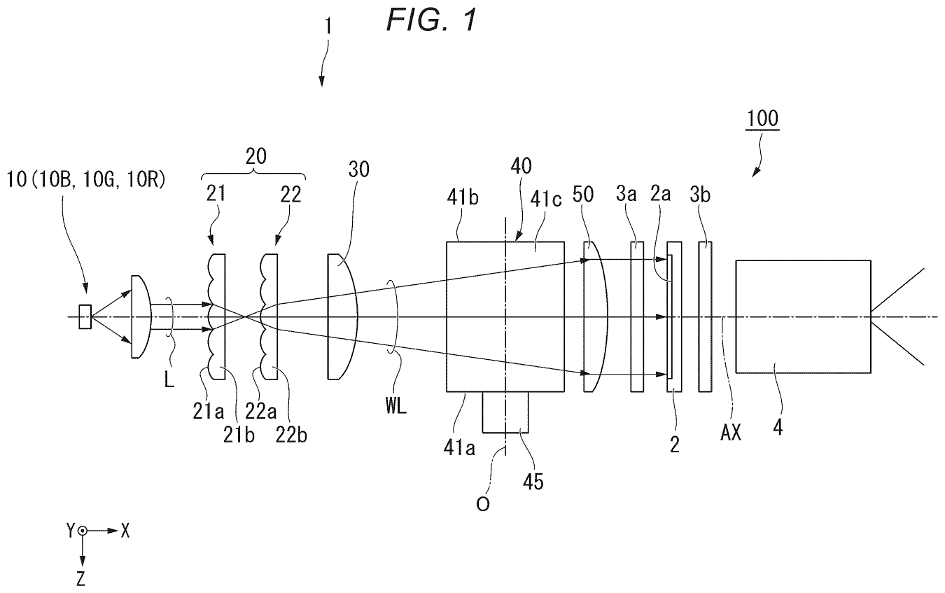

FIG. 1 is a plan view showing a schematic configuration of the projector of the embodiment as seen from the +Y side.

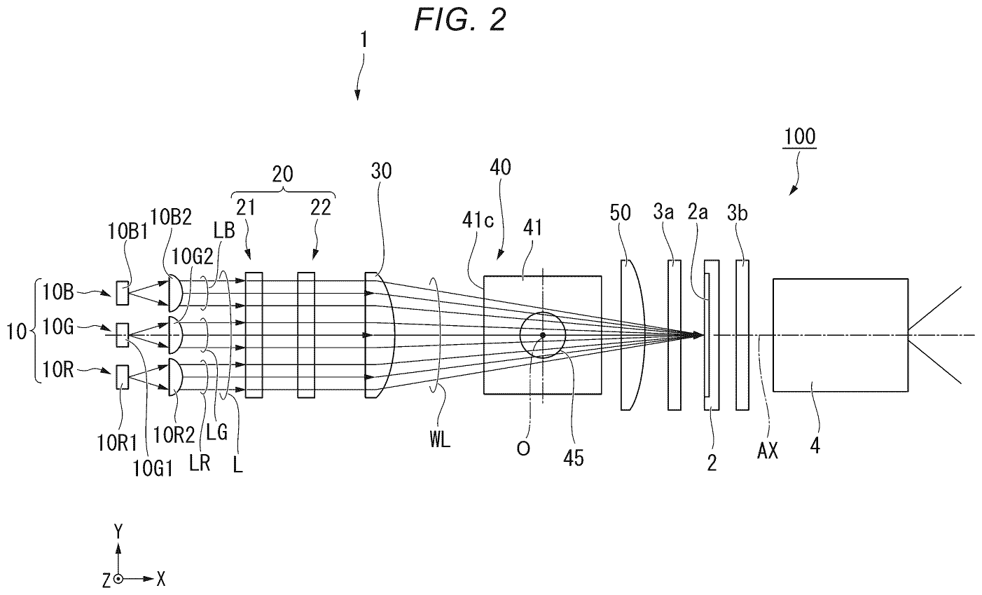

FIG. 2 is a plan view showing a schematic configuration of the projector of the embodiment as seen from the +Z side.

As shown in FIGS. 1 and 2, a projector 100 of the embodiment includes a light source 1, a light modulation device 2, a light incident-side polarizer 3a, a light exiting-side polarizer 3b, and a projection optical device 4.

The light source 1: includes a light source section 10, a light enlargement system 20, a superimposing optical system 30, a light scanning section 40, and a field lens 50.

The light source section 10 includes a blue light emitting unit 10B, a green light emitting unit 10G, and a red light emitting unit 10R. The light source section 10 causes the blue light emitting unit 10B, the green light emitting unit 10G, and the red light emitting unit 10R to emit light at different times. In the light source section 10 of the embodiment, the blue light emitting unit 10B, the green light emitting unit 10G, and the red light emitting unit 10R are formed in a single package structure. The blue light emitting unit 10B, the green light emitting unit 10G, and the red light emitting unit 10R may have independent package structures.

The blue light emitting unit 10B includes a light emitting element 10B1 as a laser diode that emits a blue beam LB, and a collimator lens 10B2 that collimates the blue beam LB. The blue beam LB is, for example, a laser beam having a blue wavelength band of 450 nm±5 nm.

The green light emitting unit 10G includes a light emitting element 10G1 as a laser diode that emits a green beam LG, and a collimator lens 10G2 that collimates the green beam LG. The green beam LG is, for example, a laser beam having a green wavelength band of 530 nm±5 nm.

The red light emitting unit 10R includes a light emitting element 10R1 as a laser diode that emits the red beam LR, and a collimator lens 10R2 that collimates the red beam LR. The red beam LR is, for example, a laser beam having a red wavelength band of 650 nm±5 nm.

In the embodiment, the cross-sectional shape perpendicular to the principal ray of each of the color beams LB, LG, and LR emitted from the light source section 10 is, for example, a substantially square shape.

The light emitting surfaces of the light emitting elements 10B1, 10G1, 10R1 of the light emitting units 10B, 10G, and 10R are arranged on the same plane. In other words, the light source section 10 of the embodiment emits an illumination light L including the plurality of color beams LB, LG, and LR emitted from the light emitting points on the same plane.

In the embodiment, the blue beam LB corresponds to an example of “first beam” of the present disclosure, and the green beam LG corresponds to an example of “second beam” of the present disclosure.

According to the configuration, the light source section 10 of the embodiment emits the illumination light L including the color beams LB, LG, and LR emitted in time sequence toward a light enlargement system 20. Therefore, the illumination light L emitted by the light source section 10 is a monochromatic light including any one of the color beams LB, LG, and LR. In the illumination light L emitted by the light source section 10, the blue beam LB, the green beam LG, and the red beam LR are aligned in the Y-axis direction. That is, the blue beam LB, the green beam LG, and the red beam LR are incident on the light enlargement system 20 through different optical paths.

The light enlargement system 20 enlarges the illumination light L emitted from the light source section 10 along the Z-axis direction to generate an enlarged illumination light WL having a rectangular shape extending along the Z axis. The enlarged illumination light WL in the embodiment corresponds to an example of “enlarged light” in the present disclosure.

The light enlargement system 20 of the embodiment includes a first lenticular lens 21 and a second lenticular lens 22. In the embodiment, since the first lenticular lens 21 and the second lenticular lens 22 are separate lenses, it is easy to manufacture the lenses.

The first lenticular lens 21 and the second lenticular lens 22 have the same shape. Therefore, the lens pitches of the first lenticular lens 21 and the second lenticular lens 22 are equal.

The first lenticular lens 21 includes a first base material 21b that is a flat plate-shaped light-transmissive substrate, and a plurality of first lenses 21a provided on the first base material 21b. The plurality of first lenses 21a are provided on the first base material 21b so as to be arranged in the Z-axis direction. Each first lens 21a is a cylindrical convex lens having positive power in the Z-axis direction and no power in the Y-axis direction. Therefore, each first lens 21a divides the illumination light L incident from the light source section 10 into a plurality of pencils of light in the Z-axis direction. Each pencil of light is diffused in the Z-axis direction in which the first lens has power.

The second lenticular lens 22 includes a second base material 22b that is a flat plate-shaped light-transmissive substrate, and a plurality of second lenses 22a provided on the second base material 22b. The plurality of second lenses 22a are provided on the second base member 22b so as to be arranged in the Z-axis direction. The plurality of second lenses 22a respectively correspond to the plurality of first lenses 21a of the first lenticular lens 21. Each second lens 22a is a cylindrical convex lens having positive power in the Z-axis direction and no power in the Y-axis direction.

The second lenticular lens 22 forms an image of each of the first lenses 21a of the first lenticular lens 21 on an image formation region 2a of a light modulation device 2, which is an illuminated region, or the vicinity thereof together with a superimposing optical system 30 in the subsequent stage in the Z-axis direction in which the second lens has power.

The first lenticular lens 21 and the second lenticular lens 22 transmit the illumination light L incident from the light source section 10 without changing the traveling direction in the Y-axis direction in which the lenses have no power. The illumination light L transmitted through the first lenticular lens 21 and the second lenticular lens 22 in the Y-axis direction is condensed by the superimposing optical system 30 to the image formation region 2a of the light modulation device 2 or the vicinity thereof.

In this manner, the light enlargement system 20 of the embodiment diffuses the illumination light L emitted from the light source section 10 in the Z-axis direction to generate an enlarged illumination light WL having a rectangular shape extending in the Z-axis direction.

The rate of change (degree of diffusion) of the luminous flux width in the Z-axis direction in the light enlargement system 20 can be adjusted, for example, by adjusting optical characteristics such as curvature and refractive index of each lens forming the first lenticular lens 21 and the second lenticular lens 22.

The light scanning section 40 scans the illuminated region with the enlarged illumination light WL incident from the light enlargement system 20 in the Y-axis direction. Specifically, the light scanning section 40 scans with the band-shaped enlarged illumination light WL extending in the Z-axis direction in the image formation region 2a of the light modulation device 2 disposed in the illuminated region in the Y-axis direction. Therefore, the light scanning section 40 can efficiently illuminate the entire image formation region 2a by scanning with the band-shaped enlarged illumination light WL in the short-side direction thereof. Since the enlarged illumination lights WL are superimposed on each other in the Y-axis direction, the uniformity of the intensity distribution in the image formation region 2a can be enhanced.

In the embodiment, a field lens 50 is provided between the light scanning section 40 and the light modulation device 2. The field lens 50 deflects the enlarged illumination light WL incident from the light scanning section 40. Thus, the light scanning section 40 can efficiently illuminate the image formation region 2a of the light modulation device 2 with the enlarged illumination light WL.

In the embodiment, the light scanning section 40 scans with the enlarged illumination light WL incident from the superimposing optical system 30 in the Y-axis direction on the image formation region 2a of the light modulation device 2.

The light scanning section 40 includes a transmissive optical element 41 and a rotational drive unit 45.

The transmissive optical element 41 is formed of a light-transmissive member that is rotatably supported. The transmissive optical element 41 is rotatable around the rotation axis O extending along the Z-axis direction. The transmissive optical element 41 is coupled to the rotational drive unit 45 including a motor or the like. The transmissive optical element 41 rotates around the rotation axis O by driving of the rotational drive unit 45.

As the glass material of the light-transmissive member forming the transmissive optical element 41, for example, a light-transmissive material such as optical glass including BK7, quartz, or resin. The transmissive optical element 41 of the embodiment has a front surface 41a and a back surface 41b that intersect the rotation axis O, and four side surfaces 41c in perpendicular contact with the front surface 41a and the back surface 41b. That is, the shape of the transmissive optical element 41 is a regular quadrangular prism having six flat surfaces including the front surface 41a, the back surface 41b, and the four side surfaces 41c. A cross-sectional shape of the transmissive optical element 41 cut along a plane perpendicular to the rotation axis O is a square shape. That is, the four side surfaces 41c have the same area, and the two side surfaces facing each other are parallel to each other. The rotation axis O coincides with the center of the square transmissive optical element 41.

The transmissive optical element 41 transmits the enlarged illumination light WL emitted from the light enlargement system 20 while rotating around the rotation axis O. Therefore, the side surface from which the enlarged illumination light WL emitted from the light enlargement system 20 is incident on the transmissive optical element 41 is not uniquely fixed, but changes with time. Similarly, the side surface from which the enlarged illumination light WL incident on the transmissive optical element 41 is emitted to the external space is not uniquely fixed, but changes with time. In the transmissive optical element 41, the side surface from which the enlarged illumination light WL emitted from the light enlargement system 20 is incident is referred to as “incident surface”. The side surface from which the enlarged illumination light WL incident from the incident surface is emitted is referred to as “exit surface”. In this case, the incident surface and the exit surface change with time, and are any two side surfaces parallel to each other of the four side surfaces 41c.

In the specification, the case where two surfaces of the transmissive optical element 41 are parallel to each other refers to a case where two surfaces forming an angle within a range of 0±5 degrees are “parallel” in consideration of processing accuracy of a glass material forming the light-transmissive member, an allowable range of the parallelism of the light, and the like.

In the case of the embodiment, the transmissive optical element 41 has the four side surfaces 41c. The number of side surfaces is not necessarily four, but is desirably 2×m (m is a natural number equal to or greater than 2). That is, the number of side surfaces is desirably an even number such as six or eight. When the number of side surfaces is the even number, all side surfaces are parallel to the opposing side surfaces and there are no non-parallel side surfaces. Thus, a stray light is rarely generated in the transmissive optical element 41, and the light use efficiency can be increased.

The light modulation device 2 is provided at the light exiting side of the light scanning section 40 on an illumination optical axis AX. The light modulation device 2 modulates the enlarged illumination light WL emitted from the light scanning section 40 according to image information to form an image light. A transmissive liquid crystal panel is used as the light modulation device 2. Examples of a method for driving the liquid crystal panel include, but not particularly limited to, a twisted nematic (TN) method, a vertical alignment (VA) method, and an in-plane switching (IPS) method.

Here, it is desirable that the size in the Z-axis direction of the enlarged illumination light WL (the enlargement direction of the enlarged illumination light WL) that illuminates the image formation region 2a of the light modulation device 2 is set to be slightly larger than the size of the image formation region 2a of the light modulation device 2. The present discloser has found that it is desirable to expand the size of the enlarged illumination light WL outward by 0.5 mm or more based on a simulation.

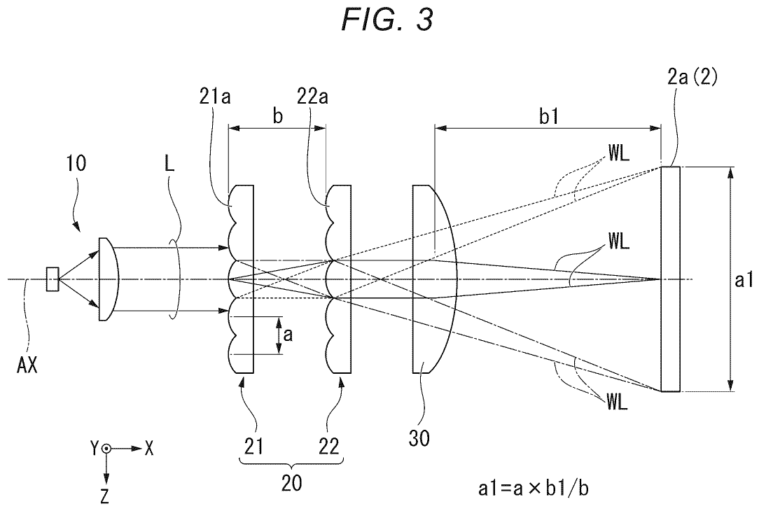

FIG. 3 shows a relationship established between the optical members in a plan view in the Y-axis direction. In FIG. 3, the light scanning section 40, the field lens 50, and the light-incident side polarizer 3a, which are not used in the description, are omitted for clarity.

In FIG. 3, the lens pitch of the first lenticular lens 21 and the second lenticular lens 22 is a, the luminous flux width of the enlarged illumination light WL in the Z-axis direction is a1, the lens-to-lens distance between the first lenticular lens 21 and the second lenticular lens 22 is b, and the distance between the superimposing optical system 30 and the light modulation device 2 is b1.

The light emitted from the first lens 21a of the first lenticular lens 21 is parallelized by the second lens 22a of the second lenticular lens 22, and an image is formed on the image formation region 2a of the light modulation device 2 by the superimposing optical system 30.

Accordingly, among the lens pitch a, the luminous flux width a1, the lens-to-lens distance b, and the distance b1, a relationship of a:a1=b:b1 is established. Therefore, the luminous flux width a1 is defined by a1=a×b1/b.

As described above, a margin of 1.0 mm or more is desirably considered for the luminous flux width in the Z-axis direction in the enlarged illumination light WL on both sides. Therefore, in consideration of the margin of the enlarged illumination light WL, a dimension S of the image formation region 2a in the Z-axis direction satisfies a relationship of the following expression (1).

$$S < ( a \times b 1 / b ) - 1. \qquad Expression ( 1 )$$

When Expression (1) is satisfied, the enlarged illumination light WL can effectively illuminate the image formation region 2a of the light modulation device 2 even when the attachment of the optical components varies or the precision of the lenticular lens is poor.

The light incident-side polarizer 3a is disposed at the light incident side of the light modulation device 2 on the illumination optical axis AX. The light exiting-side polarizer 3b is disposed at the light exiting side of the light modulation device 2 on the illumination optical axis AX. The transmission axes of the light incident-side polarizer 3a and the light exiting-side polarizer 3b are orthogonal to each other.

The light incident-side polarizer 3a transmits a linearly polarized component in a specific direction of the enlarged illumination light WL emitted from the light source section 10 toward the light modulation device 2. The light exiting-side polarizer 3b transmits a linearly polarized light emitted from the light modulation device 2 in a specific direction toward the projection optical device 4. In the case of the embodiment, since the light source section 10 uses a laser emitting element, the illumination light L incident from the light source section 10 is a linearly polarized light. However, in the transmissive optical element 41, the amount of light absorbed by the light transmissive member increases as the amount of light transmitted through the light transmissive member increases, and thermal strain may be generated in the light transmissive member. In this case, the polarization direction of the illumination light WL emitted from the light source section 10 is disturbed, and the linearly polarized light incident on the light transmissive member is converted into elliptically polarized light and is then emitted from the light transmissive member. In the case of the embodiment, by providing the light incident-side polarizer 3a, even when the polarization direction of the illumination light L is disturbed, the linearly polarized component in the specific direction can be incident on the light modulation device 2.

When quartz, which is a glass material having a small Young's modulus and a small thermal expansion coefficient, is used as the transmissive optical element 41, the polarization direction is less likely to be disturbed, and thus the light incident-side polarizer 3a provided at the light incident side of the light modulation device 2 can be omitted.

The projection optical device 4 includes a plurality of projection lenses. The projection optical device 4 enlarges and projects the image light modulated by the light modulation device 2 toward a projected surface such as a screen.

Thus, an image is displayed on the projected surface.

Behaviors of the enlarged illumination light WL transmitted through the transmissive optical element 41 will be described in detail. Since the behaviors of the color beams LB, LG, and LR contained in the enlarged illumination light WL are the same, the behavior of the blue beam LB and the behavior at switching from the blue beam LB to the green beam LG will be described below.

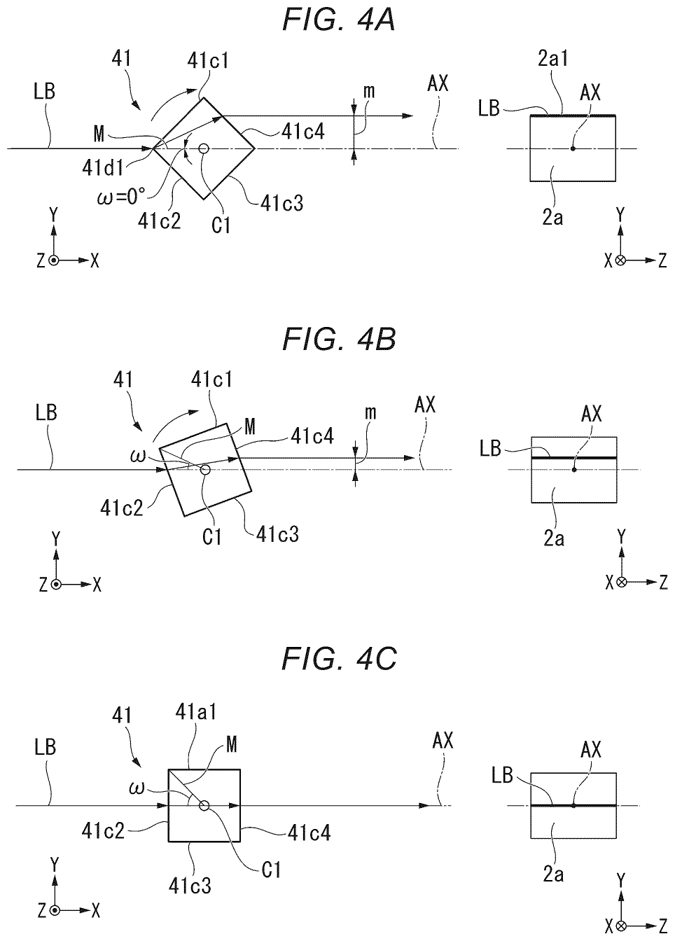

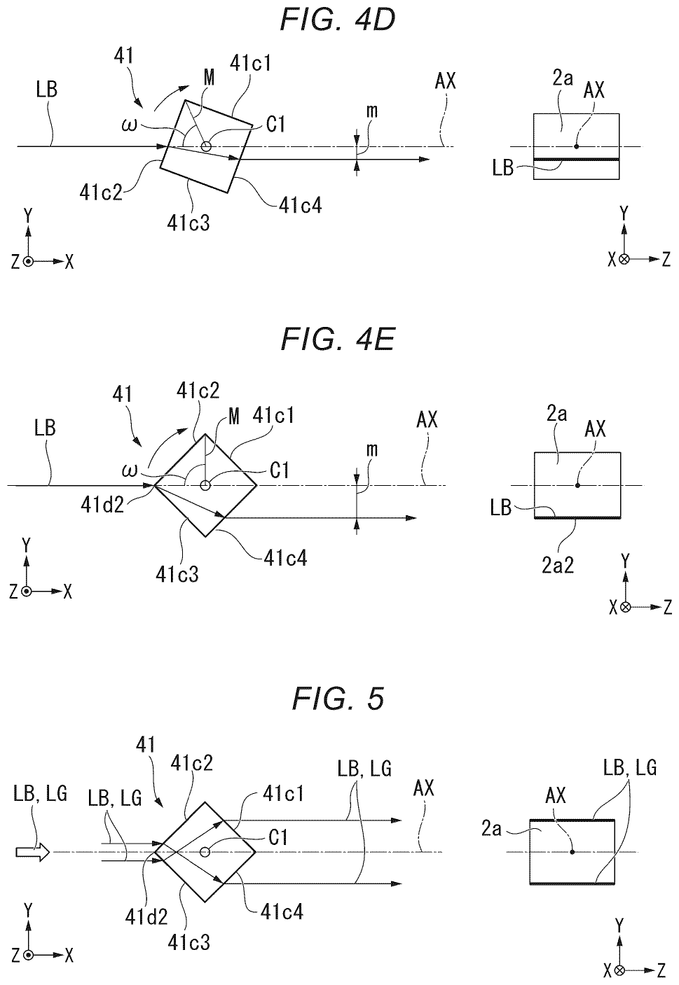

FIGS. 4A to 4E are schematic diagrams showing the behaviors of the blue beam LB when the transmissive optical element 41 rotates. In this example, the transmissive optical element 41 rotates clockwise around the rotation axis O as seen from the +Z side, and the time elapses from FIG. 4A toward the state shown in FIG. 4E. In FIGS. 4A to 4E, illustration of the rotation driving unit 45 is omitted.

In FIGS. 4A to 4E, an angle formed by the illumination optical axis AX and a straight line M connecting a top portion 41d1 as an intersection of a side surface 41c1 and a side surface 41c2 and the rotation axis O is defined as a rotation angle ω of the transmissive optical element 41. Actually, the blue beam LB has a predetermined luminous flux width in the Z-axis direction, however, here, the behavior of the principal ray traveling on the illumination optical axis AX is focused on.

In FIGS. 4A to 4E, amounts of displacement m from the illumination optical axis AX of the principal ray of the blue beam LB are shown on the left sides, and states in which the blue beam LB scans the image formation region 2a as the illuminated region are shown on the right sides.

FIG. 4A shows an initial state in which the blue beam LB is incident on the transmissive optical element 41. In the state illustrated in FIG. 4A, the straight line M and the illumination optical axis AX overlap each other, and the rotation angle ω is 0 degrees. Here, the blue beam LB is incident on the end portion at the +Y side of the side surface 41c2 at an incident angle (45 degrees). The blue beam LB is refracted in the direction (+Y side) shown in the drawing and travels inside the transmissive optical element 41. Then, the blue beam LB is also incident on a side surface 41c4 at the same incident angle as the side surface 41c2, and thus the blue beam is refracted by the side surface 41c4 and is emitted from the transmissive optical element 41. Here, since the side surface 41c2 and the side surface 41c4 are parallel to each other, the incident angle of the blue beam LB with respect to the side surface 41c2 and the incident angle of the blue beam LB with respect to the side surface 41c4 are equal, and the refraction angle of the blue beam LB incident on the side surface 41c2 and the refraction angle of the blue beam LB emitted from the side surface 41c4 have opposite signs and have equal absolute values. Accordingly, the refraction angle of the blue beam LB at the time of being incident on the side surface 41c2 and the refraction angle at the time of being emitted from the side surface 41c4 cancel each other. As a result, the blue beam LB travels parallel to the illumination optical axis AX at a position displaced from the illumination optical axis AX to the +Y side by the amount of displacement m.

Accordingly, the blue beam LB emitted from the transmissive optical element 41 is incident on an end portion 2a1 at the +Y side of the image formation region 2a of the light modulation device 2 as the illuminated region.

Then, as illustrated in FIG. 4B, when the rotation angle ω of the transmissive optical element 41 becomes larger than that in FIG. 4A, the incident angle of the blue beam LB becomes smaller and the refraction angle also becomes smaller. Therefore, the amount of displacement m of the blue beam LB from the illumination optical axis AX is smaller than that in FIG. 4A. The state in which the blue beam LB travels in parallel to the illumination optical axis AX is constantly maintained. While the rotation angle ω is from 0 degrees to 45 degrees, the amount of displacement m monotonously decreases with the increase of the rotation angle ω.

Thus, the blue beam LB emitted from the transmissive optical element 41 is incident on the position closer to the −Y side of the image formation region 2a of the light modulation device 2 than that in FIG. 4A.

Then, as illustrated in FIG. 4C, when the rotation angle ω of the transmissive optical element 41 becomes 45 degrees, which is larger than that in FIG. 4B, the straight line M and the illumination optical axis AX overlap each other, and the blue beam LB is incident perpendicularly onto the side surface 41c2. That is, the incident angle of the blue beam LB with respect to the side surface 41c2 is 0 degrees. Therefore, since the blue beam LB is incident perpendicularly onto the side surface 41c2, the blue beam LB travels inside the transmissive optical element 41 along the illumination optical axis AX without being refracted by the side surface 41c2. Then, the blue beam LB is also incident perpendicularly onto the side surface 41c4 parallel to the side surface 41c2. Therefore, the blue beam LB is emitted from the transmissive optical element 41 without being refracted by the side surface 41c4, and travels on the illumination optical axis AX. Here, the blue beam LB emitted from the transmissive optical element 41 is incident on the center part of the image formation region 2a of the light modulation device 2 in the Y-axis direction.

Then, as illustrated in FIG. 4D, when the rotation angle ω of the transmissive optical element 41 exceeds 45 degrees, the incident position of the blue beam LB changes to the position closer to the side surface 41c3 side than the center of the side surface 41c2. Here, the blue beam LB is refracted by the side surface 41c2 in the refraction direction, the direction (−Y side) illustrated in the drawing, different from that in the period up to FIG. 4B. The relationship in which the refraction angle of the blue beam LB at the time of being incident on the side surface 41c2 and the refraction angle of the blue beam LB at the time of being emitted from the side surface 41c4 cancel each other is the same as that in the period up to FIG. 4B. As a result, the blue beam LB travels parallel to the illumination optical axis AX at a position displaced from the illumination optical axis AX to the −Y side by the amount of displacement m. While the rotation angle ω is from 45 degrees to 90 degrees, the amount of displacement m monotonously increases with the increase of the rotation angle ω.

Accordingly, the blue beam LB emitted from the transmissive optical element 41 is incident on the position closer to the −Y side than the center part of the image formation region 2a of the light modulation device 2.

Then, as illustrated in FIG. 4E, the rotation angle ω of the transmissive optical element 41 becomes maximum, and the amount of displacement m becomes maximum while the state in which the blue beam LB travels parallel to the illumination optical axis AX is maintained.

Accordingly, the blue beam LB emitted from the transmissive optical element 41 is incident on an end portion 2a2 at the −Y side of the image formation region 2a of the light modulation device 2, which is the illuminated region.

As described above, the blue beam LB incident on the side surface 41c2 of the rotating transmissive optical element 41 can scan the image formation region 2a of the light modulation device 2 in the Y-axis direction.

In the state illustrated in FIG. 4E, the top portion 41d2 of the transmissive optical element 41 located at the boundary between the side surface 41c2 and the side surface 41c3 overlaps the illumination optical axis AX. In the case of the embodiment, at the time shown in FIG. 4E, the light source section 10 switches the emitted illumination light L from the blue beam LB to the green beam LG.

FIG. 5 shows the behavior of the light transmitted through the transmissive optical element 41 when the blue beam LB is switched to the green beam LG.

As shown in FIG. 5, at the time when the top portion 41d2 of the transmissive optical element 41 overlaps the illumination optical axis AX, the blue beam LB and the green beam LG are incident on both the side surface 41c2 and the side surface 41c3 of the transmissive optical element 41, and are respectively emitted┘ from the side surface 41c4 and the side surface 41c1. That is, when switched from the blue beam LB to the green beam LG, the blue beam LB and the green beam LG emitted from the transmissive optical element 41 are separated into two in the Y-axis direction. For example, when the blue beam LB and the green beam LG are respectively incident on both ends of the image formation region 2a in the Y-axis direction, different color lights are incident on the same region (both ends in the Y-axis direction) of the image formation region 2a in time sequence, and the quality of a projected image is deteriorated due to color mixture.

In contrast, in the projector 100 of the embodiment, the size of the image formation region 2a is set such that, when the enlarged illumination light WL is transmitted through the transmissive optical element 41 and separated into two beams in the Y-axis direction, the two separated beams are incident on the outside of the image formation region 2a. As a result, the occurrence of color mixture can be suppressed.

However, as the luminous flux width in the Y-axis direction of the illumination light L emitted from the t source section 10 is increased, the time for light separation of the illumination light L into two increases, the time for the illumination light L emitted from the light source section 10 is not incident on the image formation region 2a increases, and a problem that the use efficiency of the illumination light L emitted from the light source section 10 decreases arises.

The present discloser considered that when the luminous flux width of the illumination light L is too narrow, the image formation region 2a is locally heated, and on the contrary, when the luminous flux width of the illumination light L is too wide, the use efficiency of the illumination light L in the image formation region 2a decreases as described above, and thus it is desirable to set the luminous flux width of the illumination light L to be half or less of the image formation region 2a.

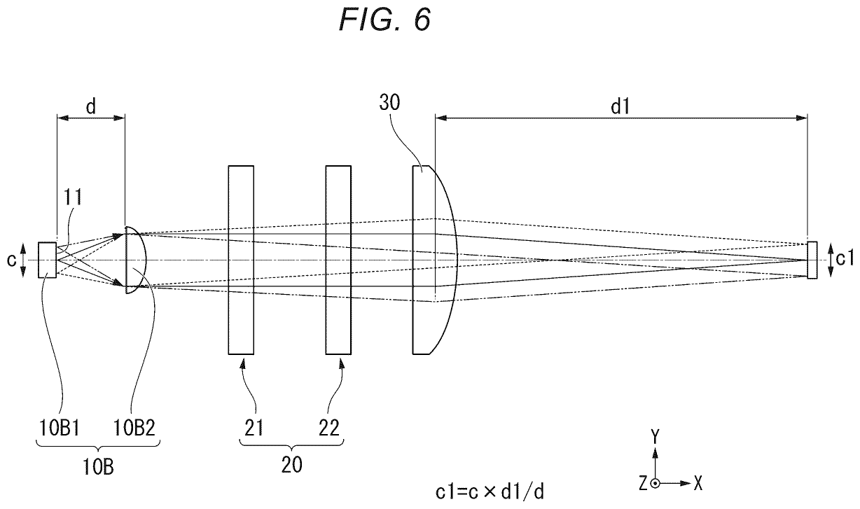

FIG. 6 shows a relationship established between the respective optical members in a plan view in the Z-axis direction. In FIG. 6, the light scanning section 40, the field lens 50, and the incident side polarizing plate 3a, which are not used in the description, are omitted for clarity. In FIG. 6, the blue light emitting unit 10B of the light source section 10 is illustrated.

In FIG. 6, the dimension in the Y-axis direction in a light emitting region 11 of the light emitting element 10B1 of the blue light emitting unit 10B is c, the luminous flux width in the Y-axis direction of the enlarged illumination light WL is c1, the focal length of the collimator lens 10B2 of the blue light emitting unit 10B is d, and the distance between the superimposing optical system 30 and the light modulation device 2 is d1.

The blue beam LB emitted from the light emitting region 11 of the light emitting element 10B1 is collimated by the collimator lens 10B2. Since the first lenticular lens 21 and the second lenticular lens 22 do not have lens power in the Y-axis direction, the blue beam LB collimated by the collimator lens 10B2 passes through the first lenticular lens 21 and the second lenticular lens 22. Then, the blue beam LB is imaged on the image formation region 2a of the light modulation device 2 by the superimposing optical system 30. Therefore, the dimension c, the luminous flux width c1, the focal length d, and the distance d1 of the light emitting region 11 satisfy the relationship of c:c1=d:d1. Therefore, the luminous flux width c1 is defined by c1=c×d1/d.

As described above, it is desirable that the luminous flux width in the Y-axis direction in the enlarged illumination light WL is equal to or less than half of the image formation region 2a in consideration of heat generation and a decrease in light use efficiency. Therefore, in the projector 100 of the embodiment, the dimension S1 of the image formation region 2a in the Y-axis direction satisfies the relationship of the following expression (2).

$$S 1 > 2 \times c \times d 1 / d \qquad Expression ( 2 )$$

When Expression (2) is satisfied, the light of the light source can be efficiently incident on the image formation region with suppressed heat generation in the image formation region.

As described above, the light source 1 of the embodiment includes the light source section 10 that emits the illumination light L including the blue beam LB, the green beam LG, and the red beam LR arranged in the Y-axis direction in the Y-axis direction, the light enlargement system 20 that generates the enlarged illumination light WL by enlarging the illumination light L in the Z-axis direction, the superimposing optical system 30 that superimposes the enlarged illumination light WL emitted from the light enlargement system 20 on the image forming region 2a of the light modulation device 2 as the illuminated region, and the light scanning section 40 that scans with the light incident from the superimposing optical system 30 on the image forming region 2a in the Y-axis direction.

In other words, the light source 1 of the embodiment includes the light source section 10 that emits the illumination light L including the plurality of beams LB, LG, and LR emitted from the light emitting points on the same plane, the first lenticular lens 21 and the second lenticular lens 22 that generate the enlarged illumination light WL by enlarging the illumination light L in the direction along the Z axis (third axis), the superimposing optical system 30 that superimposes the enlarged illumination light WL on the image formation region 2a of the light modulation device 2 as the illuminated area, and the light scanning section 40 that scans with the enlarged illumination light WL emitted from the superimposing optical system 30 in the direction along the Y axis (fourth axis).

According to the light source 1 of the embodiment, the light enlargement system 20 can convert the illumination light L emitted from the light source section 10 into the enlarged illumination light WL having a rectangular shape elongated in the Z-axis direction. The enlarged illumination light WL extends in a direction orthogonal to the light scanning direction by the light scanning section 40. Therefore, the light scanning section 40 can efficiently illuminate the entire image formation region 2a of the light modulation device 2 with the enlarged illumination light WL.

Since the light enlargement system 20 of the embodiment includes the first lenticular lens 21 and the second lenticular lens 22, the enlarged illumination light WL can be easily generated by enlarging the illumination light L emitted from the light source section 10 in the uniaxial direction.

According to the projector 100 of the embodiment, since the enlarged illumination light WL emitted from the light source 1 is scanned on the image formation region 2a of the light modulation device 2, a bright image can be projected.

### First Modification Example

A first modification example of the above described embodiment will be described.

The modification example is different from the above described embodiment in the configuration of the light enlargement system. The members in common with the above described embodiment have the same signs and the detailed description thereof will be omitted.

FIG. 7 is a plan view showing a schematic configuration of a light enlargement system 120 of the modification example as seen from the +Y side.

As illustrated in FIG. 7, the light enlargement system 120 of the modification example includes a first lenticular lens 121, a second lenticular lens 122, and a base material 130. The base material 130 is a light-transmissive substrate, the first lenticular lens 121 is provided at a first surface 130a side, and the second lenticular lens 122 is provided at a second surface 130b side opposite to the first surface 130a. That is, in the light enlargement system 120 of the modification example, the first lenticular lens 121 and the second lenticular lens 122 are integrated lenses.

In the case of the modification example, since the first lenticular lens 121 and the second lenticular lens 122 are integrated lenses, alignment of the first lenticular lens 121 and the second lenticular lens 122 is unnecessary. Therefore, according to the light source using the light enlargement system 120 of the modification example, the assembling process can be simplified.

### Second Modification Example

A second modification example of the above described embodiment will be described.

The modification example is different from the above described embodiment in the configuration of the light source section. The members in common with the above described embodiment have the same signs and the detailed description thereof will be omitted.

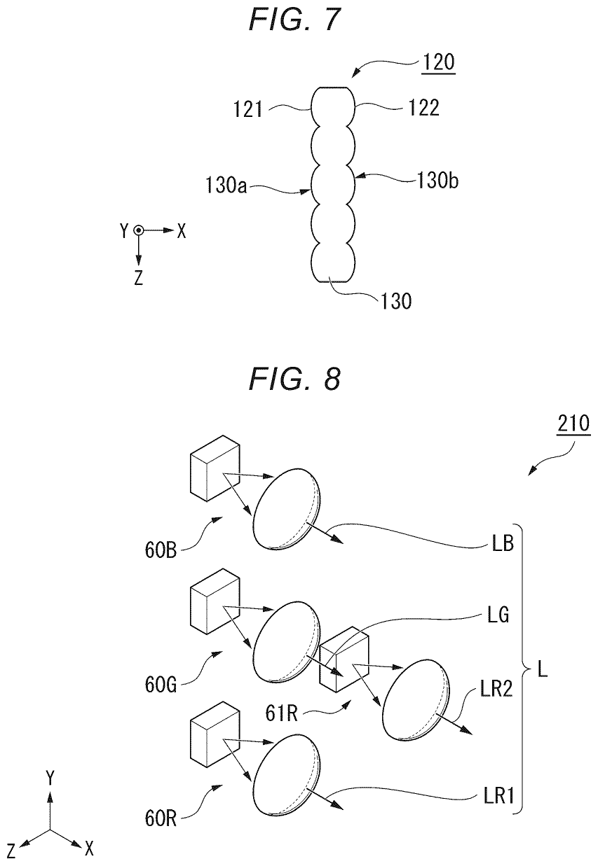

FIG. 8 is a perspective view showing a main part of a light source section 210 of the modification example.

As shown in FIG. 8, the light source section 210 of the modification example includes a blue light emitting unit 60B, a green light emitting unit 60G, a first red light emitting unit 60R, and a second red light emitting unit 61R. The light source section 210 causes the blue light emitting unit 60B, the green light emitting unit 60G, the first red light emitting unit 60R, and the second red light emitting unit 61R to emit light at different times.

The blue light emitting unit 60B has the same configuration as the blue light emitting unit 10B of the first embodiment, and emits the blue beam LB. The green light emitting unit 60G has the same configuration as the green light emitting unit 10G of the first embodiment, and emits the green beam LG. The first red light emitting unit 60R and the second red light emitting unit 61R have the same configuration as the red light emitting unit 10R of the first embodiment, and emit red beams LR1 and LR2, respectively.

In the modification example, the blue light emitting unit 60B, the green light emitting unit 60G, and the first red light emitting unit 60R are arranged in order from the +Y side to the −Y side. The second red light emitting unit 61R is disposed side by side with the first red light emitting unit 60R in the Z-axis direction.

That is, in the modification example, the illumination light L emitted by the light source section 210 includes the blue beam LB, the green beam LG, and the red beam LR1 arranged in the Y-axis direction, and the red beam LR2 arranged in the Z-axis direction with the red beam LR1. Therefore, in the case of the modification example, the luminous flux width in the Z-axis direction of the illumination light L emitted by the light source unit 210 increases.

In the embodiment, the red beam LR1 corresponds to an example of “first beam” of the present disclosure, the green beam LG corresponds to an example of “second beam” of the present disclosure, and the red beam LR2 corresponds to an example of “third beam” of the present disclosure.

According to the light source section 210 of the modification example, the color balance of the illumination light L can be further enhanced by increasing the number of red beams LR, which are more likely to be insufficient in amount of light than the blue beam LB and the green beam LG, to two.

In the modification example, a case where the number of red beams is two is taken as an example, but the number of blue beams and the number of green beams may be increased to twos. That is, two blue light emitting sections 60B may be arranged in the Y-axis direction, or two green light emitting sections 60G may be arranged in the Y-axis direction.

The light enlargement system 20 does not affect the luminous flux width in the Z-axis direction of the enlarged illumination light WL even when the luminous flux width in the Z-axis direction of the illumination light L incident from the light source section 210 changes. Therefore, according to the light source of the present disclosure, the enlarged illumination light WL having the rectangular shape elongated in the Z-axis direction by the light enlargement system 20 regardless of the luminous flux width of the illumination light L emitted from the light source section 210.

Note that the technical scope of the present disclosure is not limited to the embodiments described above, and various changes can be made thereto without departing from the spirit of the present disclosure.

In addition, the specific description of the shapes, the numbers, the arrangements, the materials, and the like of the component elements of the light source and the projector are not limited to those in the embodiments described above, and can be changed as appropriate.

For example, in the embodiments and the modification examples described above, the case where the light source section 10 emits the color beams LB, LG, and LR in time sequence as the illumination light L has been described as an example, however, a monochromatic beam may be emitted from the light source section when it is applied to a projector that displays a monochromatic color.

The present disclosure will be summarized below as appendices.

### APPENDIX 1

A light source includes a light source section that emits a light including a first beam and a second beam arranged in a direction along a first axis, in a direction intersecting the first axis, a light enlargement system that generates an enlarged light by enlarging the light in a direction along a second axis orthogonal to the first axis, a superimposing optical system that superimposes the enlarged light emitted from the light enlargement system on an illuminated region, and a light scanning section that scans with a light incident from the superimposing optical system in the direction along the first axis on the illuminated region.

According to the light source having the configuration, the light enlargement system can convert the light emitted from the light source section into the rectangular enlarged light extending in the direction along the second axis. The enlarged light extends in a direction orthogonal to the light scanning direction of the light scanning section. Therefore, the light scanning section can efficiently illuminate the entire illuminated region with the enlarged light.

### APPENDIX 2

In the light source according to Appendix 1, the light enlargement system includes a first lenticular lens that divides the light into a plurality of pencils of light and a second lenticular lens that causes the plurality of pencils of light divided by the first lenticular lens to be incident on the superimposing optical system.

According to the configuration, the enlarged illumination light extending in the second axis direction can be effectively generated by using the light enlargement system including the first lenticular lens and the second lenticular lens.

### APPENDIX 3

In the light source according to Appendix 2, the first lenticular lens includes a first base material and a plurality of first lenses provided on the first base material, and the second lenticular lens includes a second base material and a plurality of second lenses provided on the second base material.

According to the configuration, since the first lenticular lens and the second lenticular lens are separately formed, the lenses can be easily manufactured.

### APPENDIX 4

In the light source according to Appendix 2, the light enlargement system further includes a base material on which the first lenticular lens is provided at a side of a first surface and the second lenticular lens is provided at a side of a second surface opposite to the first surface.

According to the configuration, since the first lenticular lens and the second lenticular lens are integrated lenses, alignment of the first lenticular lens and the second lenticular lens is unnecessary. Therefore, the assembly process can be simplified.

### APPENDIX 5

The light source according to Appendix 1, further includes a field lens that deflects a light incident from the light scanning section.

According to the configuration, the light scanning section can efficiently illuminate the illuminated region with the enlarged light.

### APPENDIX 6

In the light source according to Appendix 1, the light emitted by the light source section further includes a third beam arranged with the first beam or the second beam in the direction along the second axis.

According to the configuration, even when the light source section emits a light including beams arranged in two directions of the first axis and the second axis, the enlarged light extending in the direction along the second axis can be generated.

### APPENDIX 7

In the light source according to appendix 1, the first beam and the second beam are different color beams, and the light source section emits the first beam and the second beam in time sequence.

According to the configuration, the color of the light emitted from the light source can be changed in time sequence.

### APPENDIX 8

A light source includes a light source section that emits a light including a plurality of beams emitted from light emitting points on the same plane, a first lenticular lens and a second lenticular lens that generate an enlarged light by enlarging the light in a direction along a third axis, a superimposing optical system that superimposes the enlarged light on an illuminated region, and a light scanning section that scans with the enlarged light emitted from the superimposing optical system in a direction along a fourth axis orthogonal to the third axis.

According to the light source having the configuration, the first lenticular lens and the second lenticular lens can convert the light including the plurality of beams emitted from the light emitting points on the same plane into the rectangular enlarged light extending in the direction along the third axis. The enlarged light extends in a direction orthogonal to the fourth axis as the light scanning direction of the light scanning section. Therefore, the light scanning section can efficiently illuminate the entire illuminated region with the enlarged light.

### APPENDIX 9

A projector includes the light source according to any one of Appendices 1 to 8, a light modulation device that modulates a light output from the light source, and a projection optical device that projects the light modulated by the light modulation device.

According to the projector having the configuration, since the enlarged light emitted from the light source scans the image formation region of the light modulation device, a bright image can be projected.

### APPENDIX 10

A projector includes the light source according to any one of Appendices 2 to 4 and 8, a light modulation device that modulates a light incident from the light source according to image information, and a projection optical device that projects the light modulated by the light modulation device, wherein the light modulation device has an image formation region, and a dimension S in a direction along an enlargement direction of the enlarged light in the image formation region satisfies a relationship of S<(a×b1/b)−1.0, a being a lens pitch of the first lenticular lens and the second lenticular lens, b being a lens-to-lens distance between the first lenticular lens and the second lenticular lens, and b1 being a distance between the superimposing optical system and the light modulation device.

According to the configuration, the light of the light source can effectively illuminate the image formation region of the light modulation device even when the attachment of the optical components varies or the precision of the lenticular lens is poor.

### APPENDIX 11

A projector includes the light source according to any one of Appendices 1 to 10, a light modulation device that modulates a light incident from the light source according to image information, and a projection optical device that projects the light modulated by the light modulation device, wherein the light modulation device has an image formation region, the light source section of the light source includes a light emitting element that emits the first beam and a collimator lens that collimates the first beam emitted from the light emitting element, and a dimension S1 of the image formation region in a direction along the first axis satisfies a relationship of S1>2×c×d1/d, c being a dimension in the direction along the first axis in a light emitting region of the light emitting element, d being a focal length of the collimator lens, and d1 being a distance between the superimposing optical system and the light modulation device.

According to the configuration, the light of the light source can be efficiently incident on the image formation region with suppressed heat generation in the image formation region.

What is claimed is:

1. A light source comprising:
a light source section that emits a light including a first beam and a second beam arranged in a direction along a first axis, in a direction intersecting the first axis;
a light enlargement system that generates an enlarged light by enlarging the light in a direction along a second axis orthogonal to the first axis;
a superimposing optical system that superimposes the enlarged light emitted from the light enlargement system on an illuminated region; and
a light scanning section that scans with a light incident from the superimposing optical system in the direction along the first axis on the illuminated region.

2. The light source according to claim 1, wherein
the light enlargement system includes a first lenticular lens that divides the light into a plurality of pencils of light and a second lenticular lens that causes the plurality of pencils of light divided by the first lenticular lens to be incident on the superimposing optical system.

3. The light source according to claim 2, wherein
the first lenticular lens includes a first base material and a plurality of first lenses provided on the first base material, and
the second lenticular lens includes a second base material and a plurality of second lenses provided on the second base material.

4. The light source according to claim 2, wherein
the light enlargement system further includes a base material on which the first lenticular lens is provided at a side of a first surface and the second lenticular lens is provided at a side of a second surface opposite to the first surface.

5. The light source according to claim 1, further comprising a field lens that deflects a light incident from the light scanning section.

6. The light source according to claim 1, wherein
the light emitted by the light source section further includes a third beam arranged with the first beam or the second beam in the direction along the second axis.

7. The light source according to claim 1, wherein
the first beam and the second beam are different color beams, and the light source section emits the first beam and the second beam in time sequence.

8. A light source comprising:
a light source section that emits a light including a plurality of beams emitted from light emitting points on the same plane;
a first lenticular lens and a second lenticular lens that generate an enlarged light by enlarging the light in a direction along a third axis;
a superimposing optical system that superimposes the enlarged light on an illuminated region; and
a light scanning section that scans with the enlarged light emitted from the superimposing optical system in a direction along a fourth axis orthogonal to the third axis.

9. A projector comprising:
the light source according to claim 1;
a light modulation device that modulates a light output from the light source; and
a projection optical device that projects the light modulated by the light modulation device.

10. A projector comprising:
the light source according to claim 2;
a light modulation device that modulates a light incident from the light source according to image information; and
a projection optical device that projects the light modulated by the light modulation device, wherein
the light modulation device has an image formation region, and
a dimension S in a direction along an enlargement direction of the enlarged light in the image formation region satisfies a relationship of S<(a×b1/b)−1.0, a being a lens pitch of the first lenticular lens and the second lenticular lens, b being a lens-to-lens distance between the first lenticular lens and the second lenticular lens, and b1 being a distance between the superimposing optical system and the light modulation device.

11. A projector comprising:
the light source according to claim 1;
a light modulation device that modulates a light incident from the light source according to image information; and
a projection optical device that projects the light modulated by the light modulation device, wherein
the light modulation device has an image formation region,
the light source section of the light source includes a light emitting element that emits the first beam and a collimator lens that collimates the first beam emitted from the light emitting element, and
a dimension S1 of the image formation region in a direction along the first axis satisfies a relationship of S1>2×c×d1/d, c being a dimension in the direction along the first axis in a light emitting region of the light emitting element, d being a focal length of the collimator lens, and d1 being a distance between the superimposing optical system and the light modulation device.
